(19) United States
(12) Patent Application Publication
(10) Pub. No.: US 2005/0076864 A1
(43) Pub. Date: Apr. 14, 2005

(54) Horizontally opposed four stroke internal combustion engine

(76) Inventor: Doo Hyun Kim, Yangsan-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,912

(22) Filed: Dec. 29, 2003

(30) Foreign Application Priority Data
Oct. 10, 2003 (KR) 10-2003-0070619

(51) Int. Cl. F02B 75/20; F02B 75/40

(52) U.S. Cl. 123/63; 123/59.6

(57) ABSTRACT

A horizontally opposed four-stroke internal combustion engine comprises a cylinder block having at least one cylinder bore horizontally extended to both ends thereof. At least one piston is respectively inserted within the at least one cylinder bore, wherein each of the at least one cylinder bores is divided into two combustion chambers. A pair of crankshafts are respectively disposed in both ends of the cylinder block and driven by the at least one piston.

### CROSS REFERENCE TO RELATED APPLICATIONS

This application claims priority of Korean Application No. 10-2003-0070619, filed Oct. 10, 2003, the disclosure of which is incorporated fully herein by reference.

### FIELD OF THE INVENTION

Generally, the present invention relates to a horizontally opposed four-stroke internal combustion engine. More particularly the engine has at least one cylinder bore divided into two combustion chambers.

### BACKGROUND OF THE INVENTION

Generally, an engine has a cylinder head, intake and exhaust valves mounted on the cylinder head, a cylinder block covered with the cylinder head, a piston slidably inserted within a cylinder bore formed in the cylinder block, and a connecting rod for converting a reciprocating motion of the piston into a rotational motion of the crankshaft.

In the conventional horizontally opposed engine, a plurality of cylinder bores, which are horizontally opposed, are formed through a cylinder block. A piston is slidably inserted within each of the cylinder bores. In the center of the cylinder block, a crankshaft is provided such that the horizontally opposed pistons are connected to the crankshaft by connecting rods. Accordingly, the reciprocating motion of the piston is converted to the rotational motion of the crankshaft.

Additionally, an intake valve unit and an exhaust valve unit are mounted on the cylinder head such that a camshaft, for driving the valve units, is connected to the crankshaft with an additional power transferring means such as a timing belt.

### SUMMARY OF THE INVENTION

The present invention provides a horizontally opposed four-stroke internal combustion engine decreasing the external engine volume and providing an engine having a simple construction.

According to an embodiment of the present invention the engine comprises a cylinder block having at least one cylinder bore horizontally extending to both ends thereof. At least one piston is respectively assembled to the at least one cylinder bore. Each of the at least one cylinder bores are divided into two combustion chambers and a pair of crankshafts are, respectively, disposed in both ends of the cylinder block. The crankshafts are driven by the at least one piston reciprocating in the at least one cylinder bore.

Preferably, each of the combustion chambers is covered with a cylinder head on which at least one intake valve, at least one exhaust valve, and a spark plug are mounted. A hole is formed through the cylinder head such that both ends of the piston are extended through the hole. A piston ring is interposed between the hole and the end of the piston. Each end of the piston is respectively connected to one of the pair of crankshafts with connecting rods. The engine further comprises at least one valve for each of intake and exhaust and at least one cam shaft for driving the valves, wherein the cam shaft is driven by the crankshaft through gears.

### BRIEF DESCRIPTION OF THE DRAWINGS

The accompanying drawings, which are incorporated in and constitute a part of the specification, illustrate an embodiment of the invention, and read together with the description, serve to explain the principles of the invention in which:

FIG. 1 illustrates a conventional horizontally opposed engine;

FIG. 2 illustrates a horizontally opposed four-stroke internal combustion engine according to an embodiment of the present invention;

FIG. 3 illustrates a specific construction of a cylinder head of the engine of FIG. 2;

FIG. 4A illustrates an intake stroke of the engine of FIG. 2;

FIG. 4B illustrates a compression stroke of the engine of FIG. 2;

FIG. 4C illustrates an ignition stroke of the engine of FIG. 2;

FIG. 4D illustrates an exhaust stroke of the engine of FIG. 2; and

FIG. 5 illustrates a connection between shafts of the engine of FIG. 2.

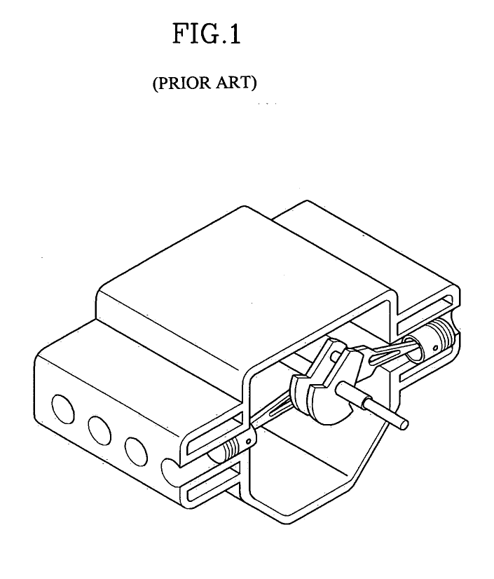

### DETAILED DESCRIPTION OF PREFERRED EMBODIMENTS

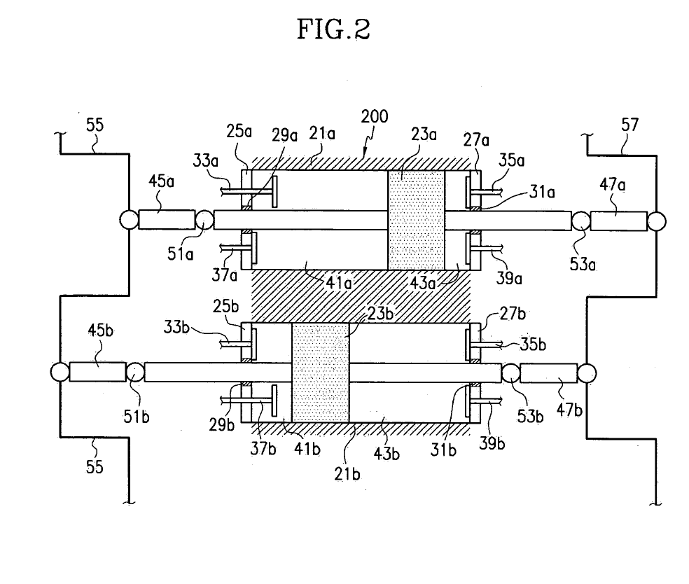

FIG. 2 illustrates a construction of a horizontally opposed four-stroke internal combustion engine. As shown in FIG. 2, a first cylinder bore 21a and a second cylinder bore 21b, which are horizontally extended, are formed through the cylinder block 200 in parallel. A first piston 23a is slidably inserted within the first cylinder bore 21a such that the first cylinder bore 21a is divided into two combustion chambers, a first combustion chamber 41a and a second combustion chamber 43a. Both ends of the first piston 23a are extended in a longitudinal direction of the first cylinder bore 21a.

A first cylinder head 25a is mounted on one end of the first cylinder bore 21a and a second cylinder head 27a is mounted on the other end of the first cylinder 21a. The ends of the first piston 23a are respectively extended through the first cylinder head 25a and the second cylinder head 27a. A first piston ring 29a is interposed between the first cylinder head 25a and the first piston 23a for sealing. A second piston ring 31a is interposed between the second cylinder head 27a and the first piston 23a for sealing. At least one first intake valve 33a and at least one first exhaust valve 37a are mounted on the first cylinder head 25a. At least one second intake valve 35a and at least one second exhaust valve 39a are mounted on the second cylinder head 27a.

One end of the first piston 23a extends from the first cylinder bore 21a and is connected to a first connecting rod 45a by a first piston pin 51a. The first connecting rod 45a is also connected to the crankshaft 55. The other end of the first piston 23a extends from the second cylinder bore 21b and is connected to a second connecting rod 47a by a second piston pin 53a. The second connecting rod 47a is also connected to the second crankshaft 57.

The second cylinder bore 21b is constructed in the same manner as the first cylinder bore 21a, and the first cylinder bore 21a and the second cylinder bore 21b are formed in parallel. The second cylinder bore 21b is divided into two combustion chambers, which are a third combustion chamber 41b and a fourth combustion chamber 43b of the engine. Accordingly, four combustion chambers 41a, 41b, 43a, 43b are formed in the cylinder block 200 utilizing two cylinder bores 21a, 21b.

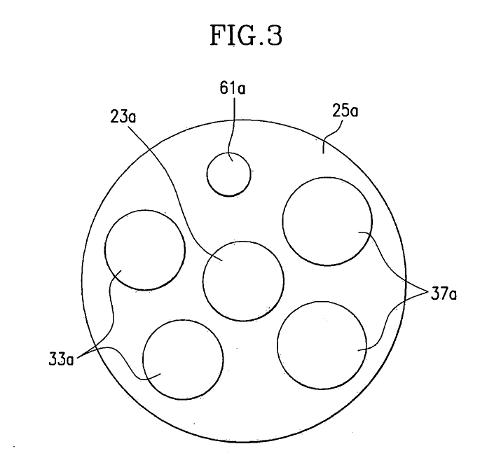

FIG. 3 illustrates a specific construction of the cylinder head of FIG. 2. As an example, one end of the first piston 23a protrudes into the center of the first cylinder head 25a and is extended to the outside of the first cylinder bore 21a. The first intake valve 33a, the first exhaust valve 37a, and a spark plug 61a are mounted on the first cylinder head about the one end of the piston 23a.

The remaining cylinder heads include a second cylinder head, a third cylinder head, and a fourth cylinder head. These cylinder heads are constructed the same as the first cylinder head 25a.

Hereinafter, each stroke in the first cylinder bore 21a of the horizontally opposed four-stroke internal combustion engine will be described.

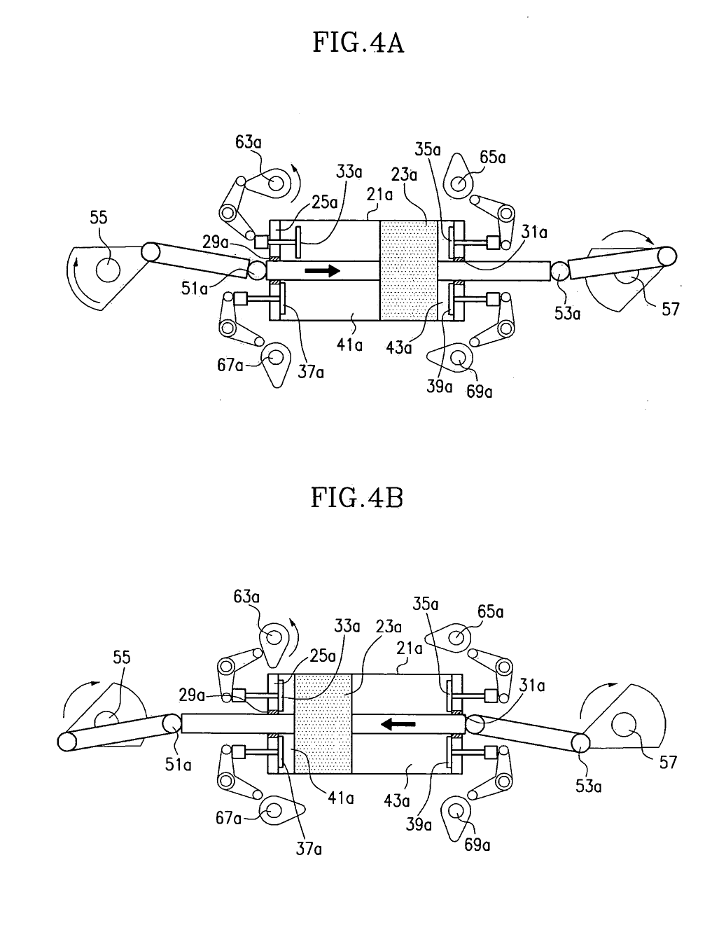

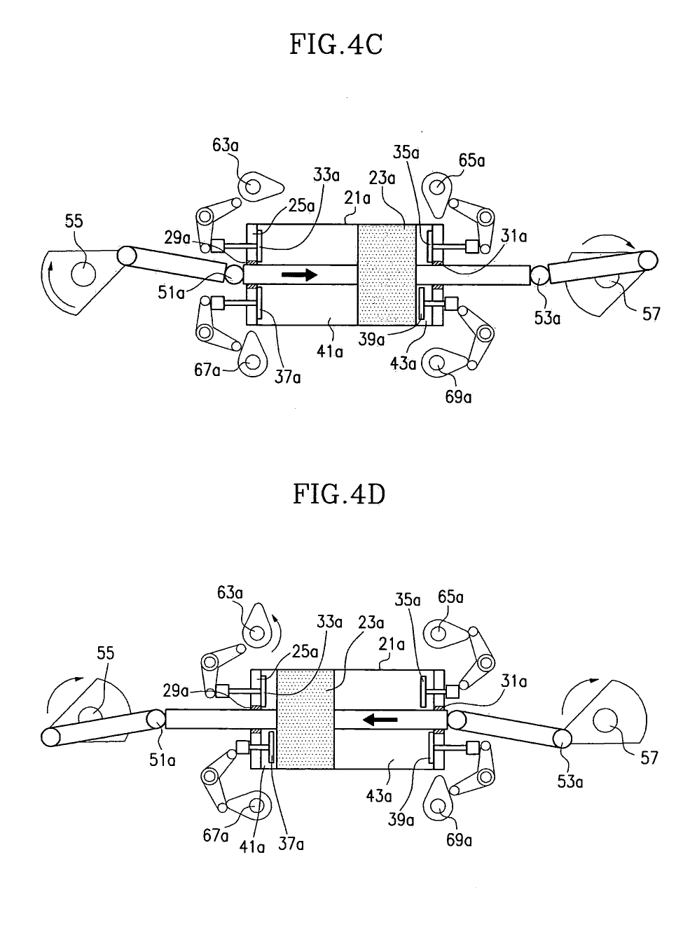

FIG. 4A illustrates an intake stroke of the first combustion chamber 41a. As shown in FIG. 4A, the first intake valve 33a is operated by the first intake cam shaft 63a and the second intake valve 35a is operated by the second intake cam shaft 65a. The first exhaust valve 37a is operated by the first exhaust cam shaft 67a and the second exhaust valve 39a is operated by the second exhaust cam shaft 69a.

When the first combustion chamber 41a is under an intake stroke, the second combustion chamber 43a is under a compression stroke. Accordingly, in the first combustion chamber 41a, the first intake valve 33a is open and the first exhaust valve 37a is closed. In the second combustion chamber 43a, the second intake valve 35a and the second exhaust valve 39a are closed. The air-fuel mixture in the second combustion chamber 43a is ignited after the first intake valve 33a closes as the first piston 23a approaches the end the first combustion chamber 41a intake stroke. An explosive force therefrom is transferred to the first piston 23a such that the first and second crankshafts 55 and 57 are driven.

FIG. 4B illustrates a compression stroke of the first combustion chamber 41a. When the first combustion chamber 41a is under a compression stroke, the air-fuel mixture that is drawn into the first combustion chamber 41a is compressed, while the second combustion chamber 43a is under an ignition stroke. At this time, the first intake valve 33a and the first exhaust valve 37a, in the first combustion chamber 41a, are both closed. The second intake valve 35a and the second exhaust valve 39a, in the second combustion chamber 43a, are also closed.

FIG. 4C illustrates an ignition stroke of the first combustion chamber 41a. When the first combustion chamber 41a is under an ignition stroke, the compressed air-fuel mixture therein is ignited by the spark plug 61a and the second combustion chamber 43a is under exhaust stroke. Accordingly, the first intake valve 33a and the first exhaust valve 37a are closed and the second intake valve 35a is closed and the second exhaust valve 39a is open. The explosive force from the air-fuel mixture in the first combustion chamber 41a is transferred to the first piston 23a such that the first and second crankshafts 55 and 57 are driven.

FIG. 4D illustrates an exhaust stroke of the first combustion chamber 41a. When the first combustion chamber 41a is under an exhaust stroke, the second combustion chamber 43a is under intake stroke. Accordingly, the first intake valve 33a is closed and the first exhaust valve 37a is open and the second intake valve 35a is open and the second exhaust valve 39a is closed.

The valve operation of the first combustion chamber 41a and the second combustion chamber 43a can be summarized as in Table 1 below.

TABLE 1

| 1^{st} combustion chamber | | | 2^{nd} combustion chamber | | |
|---|---|---|---|---|---|
| | 1^{st} intake | 1^{st} exhaust | | 2^{nd} intake | 2^{nd} exhaust |
| Stroke | valve | valve | Stroke | valve | valve |
| Intake | Open | Closed | Comp. | Closed | Closed |
| Comp. | Closed | Closed | Ignition | Closed | Closed |
| Ignition | Closed | Closed | Exhaust | Closed | Open |
| Exhaust | Closed | Open | Intake | Open | Closed |

The relationship between the four strokes in each combustion chamber can be summarized as in Table 2 below.

TABLE 2

| | 1^{st} stroke | 2^{nd} stroke | 3^{rd} stroke | 4^{th} stroke |
|---|---|---|---|---|
| 1^{st} | Intake | Comp. | Ignition | Exhaust |
| combustion | | | | |
| chamber | | | | |
| 2^{nd} | Comp. | Ignition | Exhaust | Intake |
| combustion | | | | |
| chamber | | | | |
| 3^{rd} | Exhaust | Intake | Comp. | Ignition |
| combustion | | | | |
| chamber | | | | |
| 4^{th} | Ignition | Exhaust | Intake | Comp. |
| combustion | | | | |
| chamber | | | | |

The angle of the crank pins of the first and second crankshafts 55 and 57 is set as 180°. The angle of the crank pins is determined on the basis of the number of cylinder bores formed in the cylinder block 200 by dividing 360° by the number of the cylinder bores.

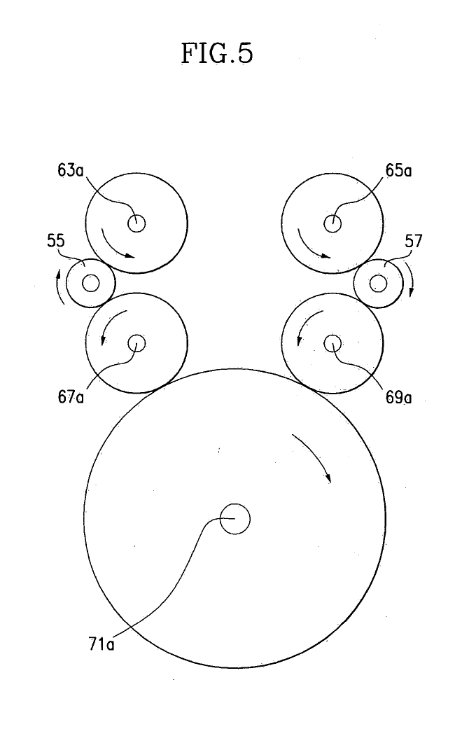

FIG. 5 illustrates a connection between the first intake cam shaft 63a, the second intake cam shaft 65a, the first exhaust cam shaft 67a, the second exhaust cam shaft 69a, the first crankshaft 55, the second crankshaft 57, and an output shaft 71a for driving the wheels of the vehicle. The first crankshaft 55 drives the first intake cam shaft 63a and the first exhaust cam shaft 67a through gears. Similarly, the second crankshaft 57 drives the second intake cam shaft 65a and the second exhaust cam shaft 69a through gears. The output shaft 71a for driving the wheels of the vehicle is driven by the first exhaust cam shaft 67a and the second exhaust cam shaft 69a.

According to the horizontally opposed four-stroke engine of this invention, in each cylinder bore, two combustion chambers are formed such that the external engine volume can be decreased. Furthermore, the distance between the camshaft and the crankshaft is decreased such that power transfer means, such as a timing belt, are not required and the construction of the engine is simplified.

1. A horizontally opposed four-stroke internal combustion engine comprising:
a cylinder block having at least one cylinder bore horizontally extended to both ends thereof;
at least one piston inserted within the at least one cylinder bore, each of the at least one cylinder bores being divided into two combustion chambers; and
a pair of crankshafts respectively disposed at both ends of the cylinder block and driven by the at least one piston reciprocating in the at least one cylinder bore.

2. The engine of claim 1, wherein each of the combustion chambers is covered with a cylinder head on which at least one intake valve, at least one exhaust valve, and a spark plug are mounted.

3. The engine of claim 2, wherein a hole is formed through the cylinder head such that the both ends of the piston are extended through the hole.

4. The engine of claim 3, wherein a piston ring is interposed between the hole and the end of the piston.

5. The engine of claim 4, wherein each end of the piston is respectively connected to one of the pair of crankshafts with a connecting rod.

6. The engine of claim 5, further comprising:
at least one valve for each of intake and exhaust for each of the combustion chambers; and
at least one cam shaft for driving the at least one valve,
wherein the cam shaft is driven by the crankshaft through gears.

7. The engine of claim 6, wherein the two combustion chambers formed by being divided by the piston include a first combustion chamber and a second combustion chamber,
wherein the relationship between the four strokes in the two combustion chambers is as shown in the table below:

| | 1^{st} stroke | 2^{nd} stroke | 3^{rd} stroke | 4^{th} stroke |
|---|---|---|---|---|
| 1^{st} | Intake | Comp. | Ignition | Exhaust |
| combustion | | | | |
| chamber | | | | |
| 2^{nd} | Comp. | Ignition | Exhaust | Intake |
| combustion | | | | |
| chamber | | | | |

8. An internal combustion engine, comprising:
a cylinder block defining an engine cylinder having two ends; and
a piston configured and dimensioned to be disposed within said engine cylinder;
wherein said piston reciprocates within said engine cylinder and interacts with each said end of said engine cylinder.

9. The engine of claim 8, wherein each end further comprises intake and exhaust valves.

10. The engine of claim 8, wherein said piston is coupled through said end to a crankshaft.

11. The engine of claim 8, wherein said piston is coupled through each said end to crankshafts.

12. The engine of claim 8, further comprising a spark plug disposed near each end.

13. An internal combustion engine, comprising:
a cylinder block defining an engine cylinder having two substantially closed ends; and
a piston configured and dimensioned to be disposed within said engine cylinder;
wherein said piston compresses gaseous matter towards each end upon reciprocating toward each end.

14. The engine of claim 13, wherein each end further comprises intake and exhaust valves.

15. The engine of claim 13, wherein said piston is coupled through said end to a crankshaft.

16. The engine of claim 13, wherein said piston is coupled through each said end to crankshafts.

17. The engine of claim 13, further comprising a spark plug disposed near each end.
